(19) United States
(12) Patent Application Publication
(10) Pub. No.: US 2020/0184567 A1
(43) Pub. Date: Jun. 11, 2020

(54) SYSTEM AND METHOD TO AUTOMATE TRANSACTION-BASED RISK ASSIGNMENT

(71) Applicants: Brandon A. Banks, West Hartford, CT (US); Daniel L Campany, Wethersfield, CT (US); Andrew Thomas Hausmann, New Haven, CT (US); Christopher S. Lowell, Boston, MA (US); Doug A Summerson, Canton, CT (US); Albert Lee Whitley, JR., Brooklyn, NY (US)

(72) Inventors: Brandon A. Banks, West Hartford, CT (US); Daniel L Campany, Wethersfield, CT (US); Andrew Thomas Hausmann, New Haven, CT (US); Christopher S. Lowell, Boston, MA (US); Doug A Summerson, Canton, CT (US); Albert Lee Whitley, JR., Brooklyn, NY (US)

(21) Appl. No.: 16/214,460

(22) Filed: Dec. 10, 2018

(51) Int. Cl. G06Q 40/08; G06Q 10/10

(52) U.S. Cl. CPC G06Q 40/08; G06Q 10/103

(57) ABSTRACT

Some embodiments are directed to an automated transaction-based risk assignment. A risk relationship data store may contain electronic records that represent a plurality of risk relationships between an enterprise and a plurality of entities, and each record may include a relationship identifier and attribute resource values associated with risk attributes. A back-end application computer server may receive an indication of a transaction between a first and second entity and interact with the first entity to create a definition document for the transaction. The server may also receive from the first entity an indication that a transaction-based risk relationship should be created with the enterprise in connection with the transaction. Responsive to the received indication, the server may automatically establish attribute resource values associated with risk attributes based on data in the definition document and store the established attribute resource values associated with risk attributes in the risk relationship data store.

### BACKGROUND

It may be advantageous to protect against unexpected risks, such as those associated with computer systems and/or transaction-based tasks. For example, it might be advantageous for a vendor or other entity to protect itself when performing an episodic or “one time only” undertaking. Manually this type of risk protection, however, can be a complicated, time consuming, and inconvenient task, especially when there are a substantial number of inter-related systems, entities, and/or other factors involved in an agreement. For example, freelancers often do not purchase insurance for relatively small jobs due to the difficulties in pricing and obtaining such insurance (e.g., the vendor might need to contact an insurance agent and answer a series of questions about the job).

It would be desirable to provide systems and methods to provide automated transaction-based risk assignments in a way that provides faster, more accurate results as compared to traditional approaches.

### SUMMARY OF THE INVENTION

According to some embodiments, systems, methods, apparatus, computer program code and means are provided to provide automated transaction-based risk assignments in a way that provides faster, more accurate results as compared to traditional approaches and that allow for flexibility and effectiveness when reviewing results associated with the assignments. In some embodiments, a system may provide an automated transaction-based risk assignment via back-end application computer server of an enterprise. The system may include a risk relationship data store containing electronic records that represent a plurality of risk relationships between the enterprise and a plurality of users (e.g., a relationship identifier and a set of attribute resource values associated with risk attributes). The system may receive an indication of a transaction between a first and second entity and interact with the first entity to create a definition document for the transaction. The server may also receive from the first entity an indication that a transaction-based risk relationship should be created with the enterprise in connection with the transaction. Responsive to the received indication, the server may automatically establish attribute resource values associated with risk attributes based on data in the definition document and store the automatically established attribute resource values associated with risk attributes in the risk relationship data store.

Some embodiments comprise: means for receiving, at a back-end application computer server, an indication of a transaction between a first entity and a second entity; means for interacting with the first entity to create a definition document associated with the transaction; means for receiving from the first entity an indication that a transaction-based risk relationship should be created with the enterprise in connection with the transaction; responsive to the received indication, means for automatically establishing attribute resource values associated with risk attributes based on data in the definition document; and means for storing the automatically established attribute resource values for the risk attributes in a risk relationship data store, wherein the risk relationship data store contains electronic records that represent a plurality of risk relationships between the enterprise and a plurality of entities, each electronic record including a relationship identifier and a set of attribute resource values associated with risk attributes.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to provide automated transaction-based risk assignments in a way that provides faster, more accurate results as compared to traditional approaches. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system in accordance with some embodiments.

FIG. 2 illustrates a method according to some embodiments of the present invention.

FIGS. 3 through 6 illustrate transaction-based risk relationship displays in accordance with some embodiments.

FIG. 7 is a transaction entity matching method according to some embodiments.

FIGS. 8 through 10 illustrate transaction entity matching displays in accordance with some embodiments.

FIG. 11 is a post-transaction method according to some embodiments.

FIGS. 12 through 15 illustrate post transaction displays in accordance with some embodiments.

FIG. 16 is a block diagram of an apparatus in accordance with some embodiments of the present invention.

FIG. 17 is a portion of a tabular risk relationship database according to some embodiments.

FIG. 18 illustrates an overall process in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access, and/or accuracy of communications between devices by implementing a specific new method and system as defined herein. The present invention is a specific advancement in the area of electronic risk protection by providing benefits in data accuracy (e.g., basing underwriting decisions directly on information in a statement of work), data availability, and data integrity and such advances are not merely a longstanding commercial practice. The present invention provides improvement beyond a mere generic computer implementation as it involves the processing and conversion of significant amounts of data, from multiple sources, in a new beneficial manner as well as the interaction of a variety of specialized client and/or third-party systems, networks, and subsystems. For example, in the present invention information may be processed, updated, and analyzed via back-end-end application server to accurately improve an analysis of risk and the exchange of information, thus improving the overall efficiency of the system associated with message storage requirements and/or bandwidth considerations (e.g., by reducing the number of messages that need to be transmitted via network). Moreover, embodiments associated with collecting accurate information might further improve risk values, predictions of risk values, allocations of resources, electronic record processing decisions, etc.

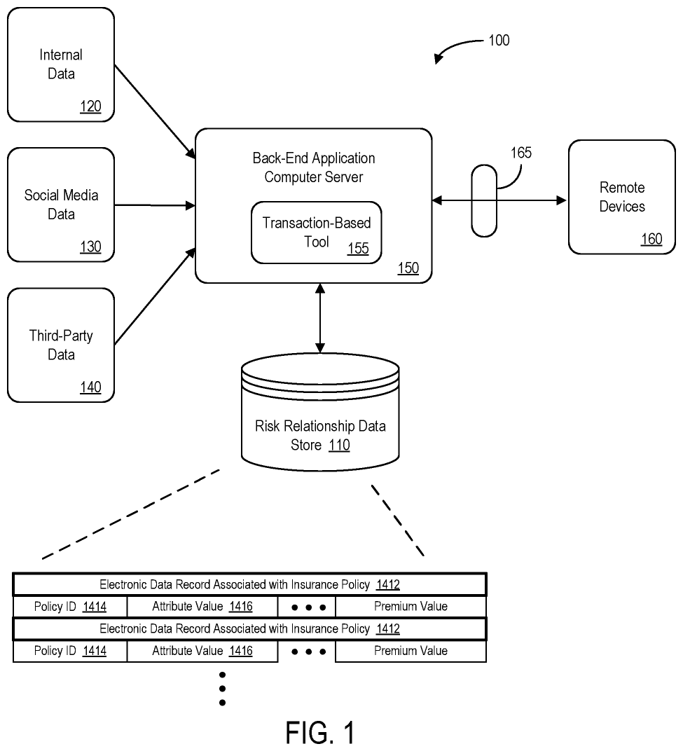

FIG. 1 is a high-level block diagram of a system 100 according to some embodiments of the present invention. In particular, the system 100 includes a back-end application computer server 150 (e.g., associated with an enterprise such as an insurance company) that may access information in a risk relationship data store 110 (e.g., storing a set of electronic records representing risk relationships or associations, each record including, for example, one or more risk relationship identifiers, attribute variables, premium values, etc.). The back-end application computer server 150 may also retrieve information from other data stores or sources 120, 130, 140 in connection with a transaction-based tool 155 and apply algorithms and/or models to the electronic records (e.g., to help define a contract and/or make underwriting decisions). The other data stores might include, for example, internal data 120 (e.g., associated with past insurance agreements), social media data 130 (e.g., storing reputation information), third-party data 130 (e.g., storing credit scores, communication addresses, motor vehicle information, or court records), etc. The back-end application computer server 150 may also exchange information with a remote device 160 (e.g., a smartphone) associated with a vendor or freelancer (e.g., via communication port 165 that might include a firewall). According to some embodiments, an interactive graphical user interface platform of the back-end application computer server 150 (and, in some cases, third-party data) may facilitate the display of information associated with the transaction-based tool 155 via one or more remote computers (e.g., to gather additional information about a contract or risk relationship) and/or the remote device 160. For example, the remote device 160 may transmit updated information (e.g., an adjusted statement of work) to the back-end application computer server 150. Based on the updated information, the back-end application computer server 150 may adjust data from the risk relationship data store 110 and automatically calculate and display updated values. Note that the back-end application computer server 150 and/or any of the other devices and methods described herein might be associated with a cloud-based environment and/or a third party, such as a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate updates of electronic records in the risk relationship data store 110. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the risk relationship data store 110. The risk relationship data store 110 might, for example, store electronic records representing a plurality of existing risk associations (e.g., insurance policies), each electronic record having a set of attribute values including a resource value (e.g., monetary amounts associated with premiums, deductibles, coverage limits, etc.). The risk relationship data store 110 may also contain information about prior and current interactions with entities, including those associated with the remote devices 160. The risk relationship data store 110 may be locally stored or reside remote from the back-end application computer server 150. As will be described further below, the risk relationship data store 110 may be used by the back-end application computer server 150 in connection with an interactive user interface to provide information via the transaction-based tool 155. Although a single back-end application computer server 150 is shown in FIG. 1, any number of such devices may be included. Moreover, various devices described herein might be combined according to embodiments of the present invention. For example, in some embodiments, the back-end application computer server 150 and the risk relationship data store 110 might be co-located and/or may comprise a single apparatus.

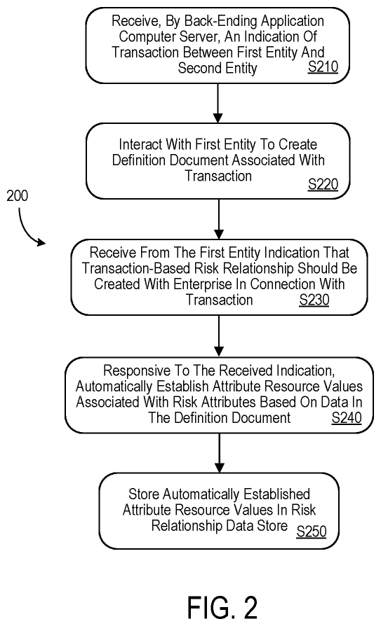

Note that the system 100 of FIG. 1 is provided only as an example, and embodiments may be associated with additional elements or components. According to some embodiments, the elements of the system 100 automatically transmit information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server may receive an indication of a transaction between a first entity and a second entity. For example, the transaction might be associated with a freelance job being performed by a vendor for a client. The indication of the transaction might include, for example, a client identifier (e.g. a business name or user identifier), a project type, a work description, etc. As used herein, the terms “transaction” and “transaction-based” may refer to episodic or contact-based work and/or related insurance policies (e.g., small commercial business insurance). The transaction-based task might be associated with a substantially short-term risk (e.g., associated with property, automobile, or computer insurance policies) and be relatively limited in scope (e.g., covering a particular service being provided instead of an entire business). According to some embodiments, the first and/or second entities might be associated with multiple vendors and/or multiple clients.

At S220, the system may interact with the first entity to create a definition document associated with the transaction. The definition document might comprise, for example, a Statement Of Work (“SOW”) or Request For Proposal (“RFP”) that defines service deliverables to be delivered from the vendor to the client. At S230, the system may receive from the first entity an indication that a transaction-based risk relationship should be created with the enterprise in connection with the transaction. For example, the vendor might indicate that he or she is interested in purchasing professional liability insurance for a particular job. Note that embodiments might be associated with other types of insurance, such as general liability insurance, cyber insurance, automotive insurance, or any other type of insurance product.

Responsive to the received indication, at S240 the system may automatically establish attribute resource values associated with risk attributes based on data in the definition document. That is, information already defined by the vendor can be used to make underwriting decisions without needing to ask the vendor to answer additional questions. At S250, the system may store the automatically established attribute resource values for the risk attributes in a risk relationship data store. The risk relationship data store might contain, for example, electronic records that represent a plurality of risk relationships between the enterprise and a plurality of entities, each electronic record including a relationship identifier and a set of attribute resource values associated with risk attributes.

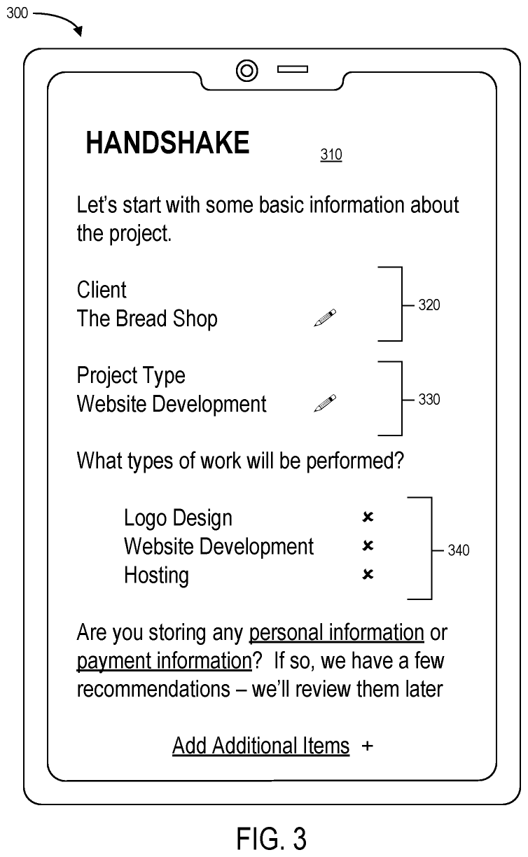

FIGS. 3 through 6 illustrate transaction-based risk relationship displays in accordance with some embodiments. In particular, FIG. 3 illustrates a smartphone 300 display 310 that may be used to define a transaction between a vendor and a client. The display 310 might include, for example, a client name or identifier 320, a project type 330, and/or the types of work 340 associated with the project. According to some embodiments, information on the display 310 might be automatically generated when the vendor (e.g., a web developer) receives a Request For Proposal (“RFP”) from a client, and he or she may use the transaction-based application to help plan a response. For example, after a brief setup where the application learns about the developer and the business, a SOW may be interactively generated. The SOW might describe deliverables and services, and the transaction-based application might make recommendations about how to best structure a contract for the arrangement. The application might also highlight considerations to help the developer better mitigate risks to cover unexpected circumstances (e.g., by suggesting certain types of computer coverages when the vendor will be locally storing personal or payment information about the client).

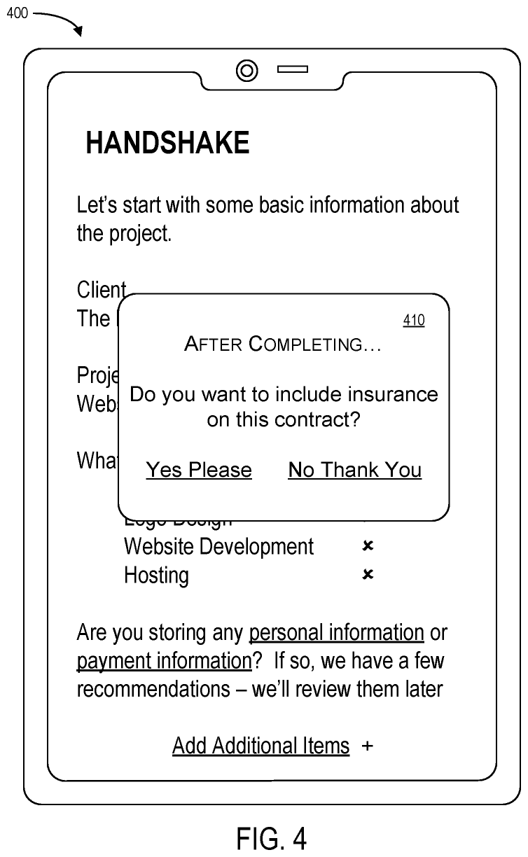

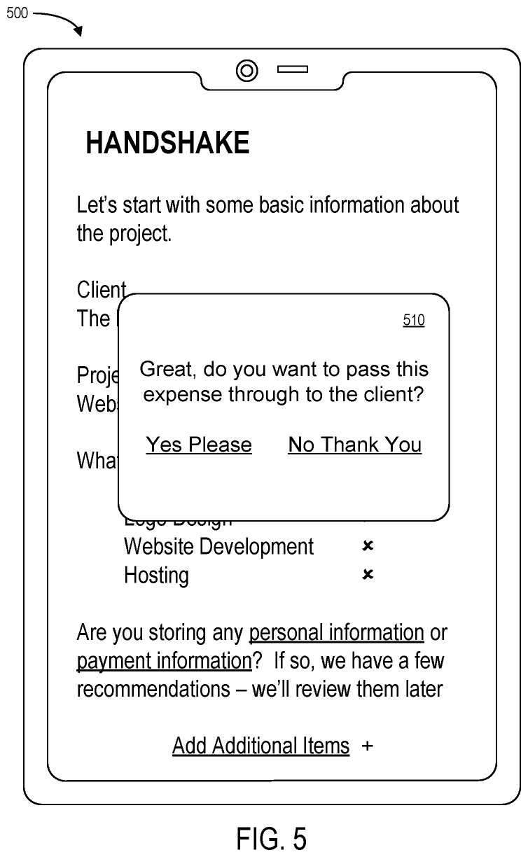

In addition to defining the deliverables (e.g., services) and the client, the display 310 might further be used to provide revenue data, duration data (e.g., when the task must be completed), exclusions (e.g., a landscaper might mow the lawn but not chip wood). Note that the transaction-based application might only offer insurance when an enterprise has a desire for that particular type of business (e.g., based on business rules and logic). Many different types of insurance might be suggested to a vendor for a project, such as property insurance (e.g., only covering a particular work location), general liability insurance, professional liability insurance, etc. As illustrated in FIG. 4, a smartphone 400 might ask the vendor if he or she is interested in purchasing insurance 410 for the particular task. If so, the vendor might be asked whether the expense should be passed along to the client as illustrated 510 by the smartphone 500 of FIG. 5. Thus, embodiments may provide a SOW or RFP quoting platform that can act as a risk selection tool for an enterprise (that is, the enterprise might evaluate a potential transaction and decide whether or not it wants to suggest an insurance product). The transaction-based application might also explain the various types of insurance while the vendor is building the SOW. Note that many different types of vendors might utilize such an application, such as designers (including web and graphic designers), writers (for a journal or online publication), contractors e.g., (general building contractor), workers in the shared economy, etc.

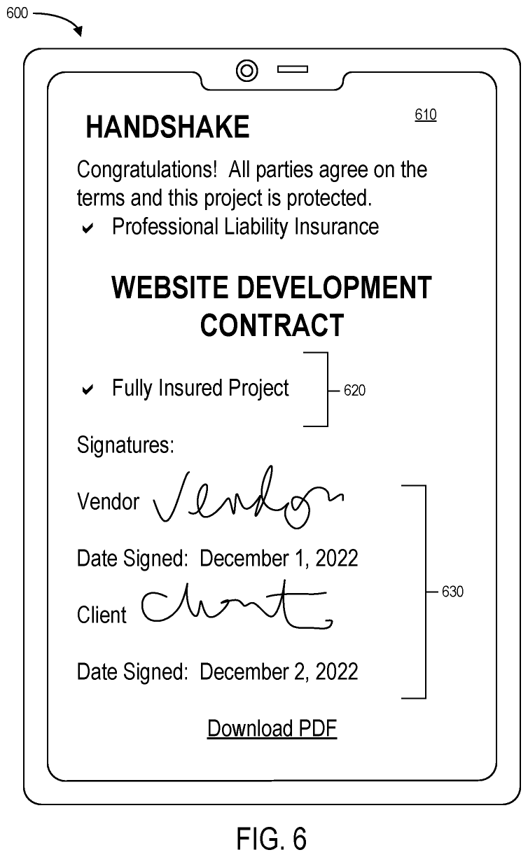

The application might post legal documents online for all parties to collaborate and agree upon particular language and details. For example, the smartphone 600 of FIG. 6 illustrates a display 610 associated with a finalized contract (that is fully insured 620). Once the contract is agreed to, the application may let the parties electronically sign 630 the document, and document may be safely and securely stored in the cloud. According to some embodiments, the parties may be able to download a version of the contract for their records (e.g., by downloading a pdf file).

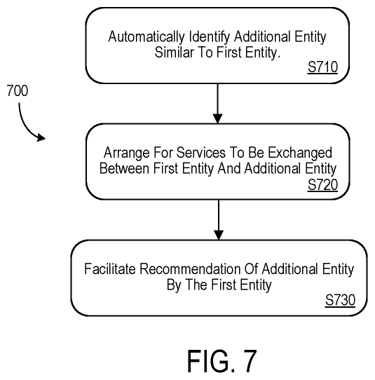

According to some embodiments, a matching platform may let contracts work with one another and/or exchange time, goods, and/or services for value. That is, instead of (or in addition to) matching a freelancer with a client, the system may match a freelancer with other freelancers. Such a feature might, for example, let a vendor increase the size of the jobs that can be accepted and/or improve the timeliness of his or her work. Moreover, freelancers with complimentary skills can pair those skills to provide better service for clients. FIG. 7 is a transaction entity matching method according to some embodiments. At S710, the system might automatically identify an additional entity that is similar to a first entity. For example, when the vendor is a craftsperson, the system might automatically identify other craftspeople in the same geographic location. The platform might, according to some embodiments, provide flexibility to leverage a vendor community in various ways. For example, at S720, the system might arrange for services to be exchanged between the first entity and an additional entity (e.g., to efficient trade or barter his or her skills). At S730, the system may facilitate a recommendation of an additional entity by the first entity.

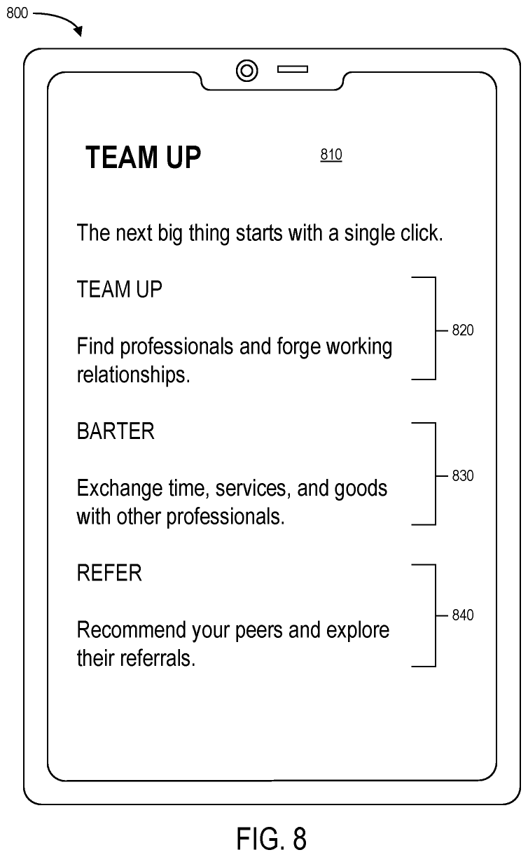

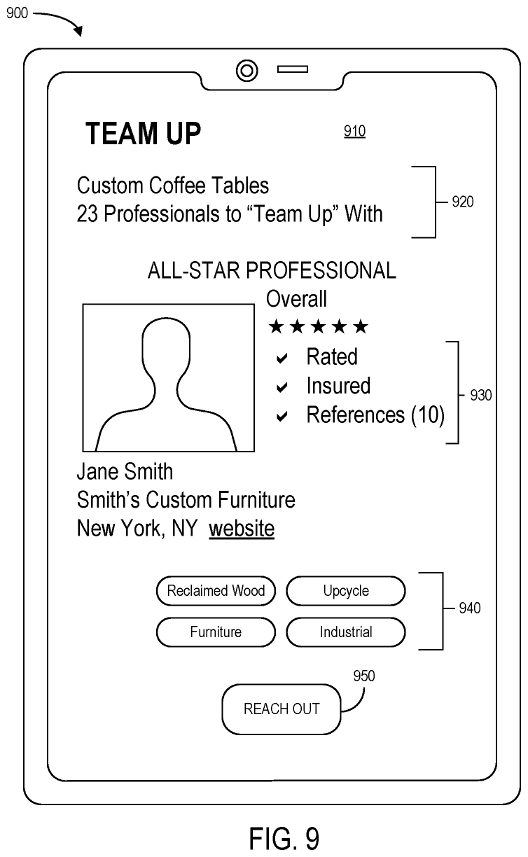

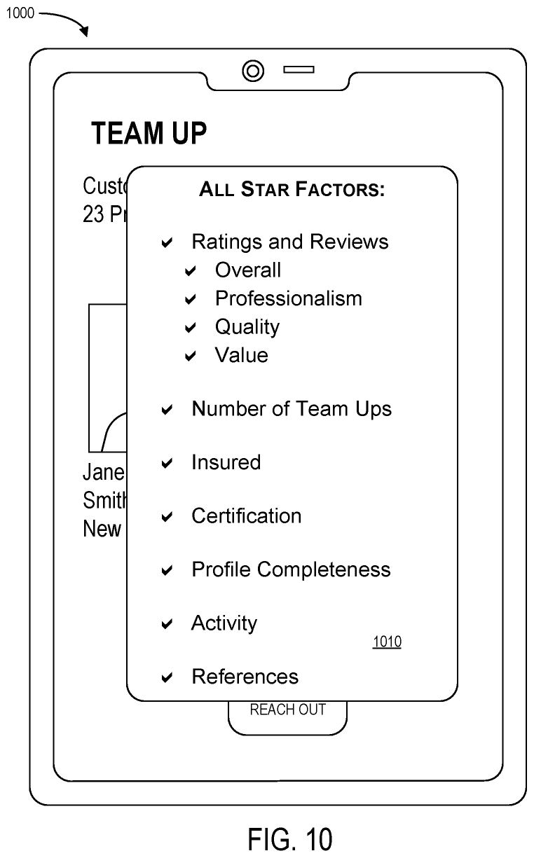

By way of example, the system might let a vendor search and filter through professional profiles that have a needed skill set and/or availability. FIGS. 8 through 10 illustrate transaction entity matching displays in accordance with some embodiments. In particular, FIG. 8 illustrates a smartphone 800 providing a vendor options display 810. The display 810 might let the vendor search for other professionals 820, find barter opportunities 830, and/or make referrals for other vendors 840. FIG. 9 illustrates a smartphone 900 providing a vendor profile display 910. The profile display 910 might include, for example, an identifier 920, a rating 930, and work descriptions 940 for a vendor along with a breadth of information pulled from prior contracts, RFPs, SOW, insurance policies, and/or third-party applications (e.g., LinkedIn® and Google®). The display 910 might further let a vendor “Reach Out” 950 to the other vendor (e.g., and automatically establish a communication link between them). As illustrated by the smartphone 1000 of FIG. 10, the factors 1010 that might be included in a vendor's overall rating or status might include reviews (e.g., about professionalism, quality, or value), a number of “team ups” (where that vendor partnered with other vendors in the system), an insured status, certifications, profile completeness, activity data, references, etc.

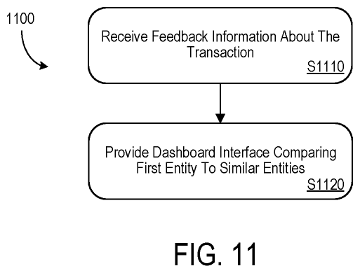

After a transaction-based job is completed, the system may continue to collect information about the task. For example, FIG. 11 is a post-transaction method according to some embodiments. At S1110, the system may receive feedback information about the transaction. For example, the feedback information might include a numerical score, review text, a photograph or video of a completed product, an overall score, a professionalism score, a timeliness score, a quality score, a value score, a number of associations, insurance information, certification information, profile completeness information, activity information, references information, third-party data, etc. At S1120, the system may provide a dashboard interface that compares the first entity to similar entities.

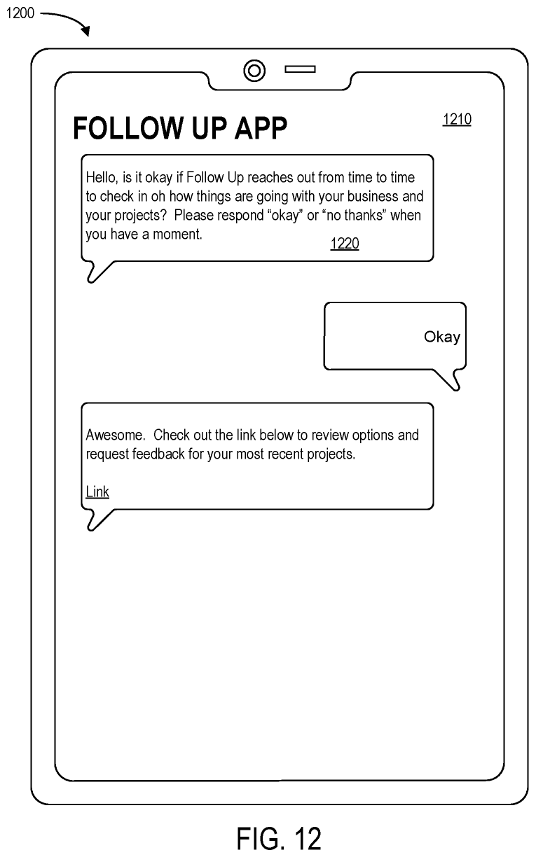

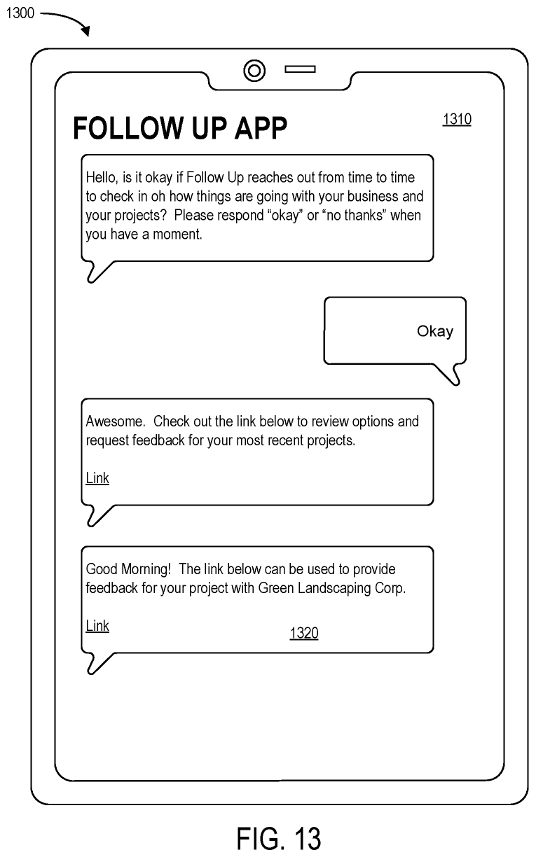

For example, FIGS. 12 through 15 illustrate post transaction displays in accordance with some embodiments. In particular, FIG. 12 illustrates a smartphone 1200 providing a display 1210 with interactive text messages 1220 (and associated links) between a vendor or client and the platform after a transaction is complete. Similarly, FIG. 13 includes a smartphone 1300 providing a display 1310 where the platform 1320 is requesting feedback information that can be compiled in a report for a vendor or client (and might also be used to facilitate and inform insurance underwriting decisions).

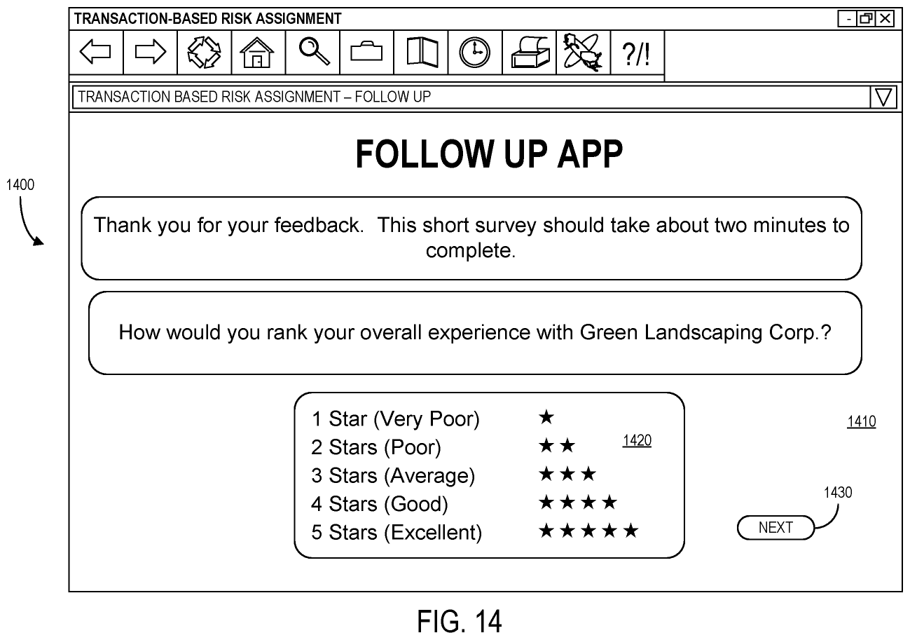

FIG. 14 is a computer display 1400 providing a feedback display 1410 for a vendor or client. According to some embodiments, a vendor or client might choose who he or she wants to collect feedback from (clients, peers, etc.), which channels he or she would like to reach out to (e.g., email or text messages), and/or what type of feedback he or she might be interested in. The display 1410 includes a star rating 1420 and/or a “Next” icon 1430 to let a person provide additional details.

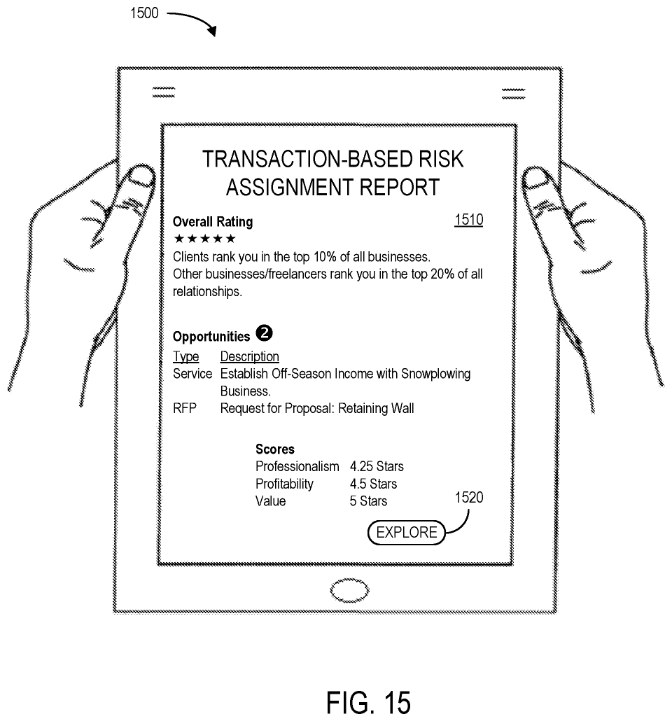

FIG. 15 is a table computer 1500 providing a feedback dashboard display 1510 in accordance with some embodiments. The display 1510 includes an overall rating, opportunities (e.g., to grow the business), and an option to “Explore” icon 1520 to let the vendor or client see further details (e.g., by “drilling down” into the data). Note that feedback information might include professionalism, quality, value, timeliness, likeliness to recommend, etc. According to some embodiments, a vendor might provide feedback to a level of detail that works best for them. For example, if they would prefer to run through at a high level and simply provide ratings, they can quickly complete the form in less than a minute. If, however, they want to provide more detail, they have that capability as well.

According to some embodiments, the application or platform will notify a vendor when feedback is available. The dashboard display 1510 might provide personalized feedback that shows the vendor how it compares to similar businesses. The dashboard display 1510 might also feed the vendor opportunities, insights, and/or ideas about how it might grow the business. According to some embodiments, this information may provide an opportunity for analytics (e.g., compare a landscaper to other landscapers) and an enterprise might use information learned from a previously generated SOW and/or information about other vendors (e.g., at this time of the year, similar jobs have been accepted for approximately $500).

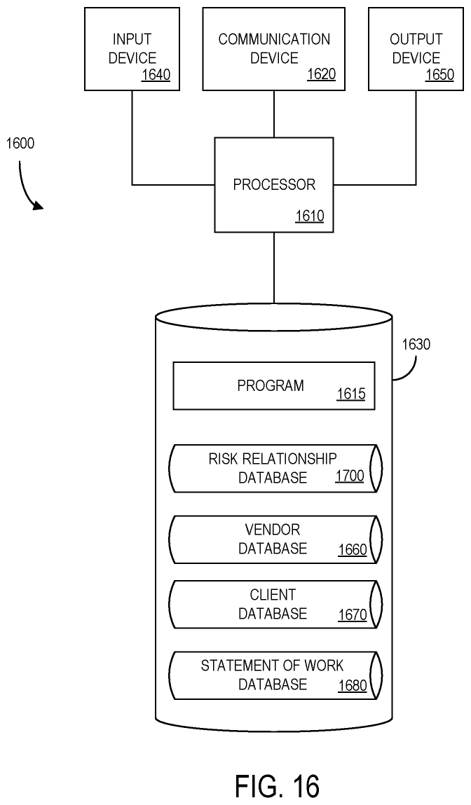

The embodiments described herein may be implemented using any number of different hardware configurations. For example, FIG. 16 illustrates an apparatus 1600 that may be, for example, associated with the systems 100, 1400 described with respect to FIGS. 1 and 14, respectively. The apparatus 1600 comprises a processor 1610, such as one or more commercially available Central Processing Units (“CPUs”) in the form of one-chip microprocessors, coupled to a communication device 1620 configured to communicate via communication network (not shown in FIG. 16). The communication device 1620 may be used to communicate, for example, with one or more remote vendor/client computers and or communication devices (e.g., PCs and smartphones). Note that communications exchanged via the communication device 1620 may utilize security features, such as those between a public internet user and an internal network of the insurance enterprise. The security features might be associated with, for example, web servers, firewalls, and/or PCI infrastructure. The apparatus 1600 further includes an input device 1640 (e.g., a mouse and/or keyboard to enter information about task, a client, a SOW, insurance details, etc.) and an output device 1650 (e.g., to output reports regarding contracts and insurance documents).

The processor 1610 also communicates with a storage device 1630. The storage device 1630 may comprise any appropriate information storage device, including combinations of magnetic storage devices (e.g., a hard disk drive), optical storage devices, mobile telephones, and/or semiconductor memory devices. The storage device 1630 stores a program 1615 and/or a risk analysis tool or application for controlling the processor 1610. The processor 1610 performs instructions of the program 1615, and thereby operates in accordance with any of the embodiments described herein. For example, the processor 1610 may receive an indication of a transaction between a first and second entity and interact with the first entity to create a definition document for the transaction. The processor 1610 may also receive from the first entity an indication that a transaction-based risk relationship should be created with the enterprise in connection with the transaction. Responsive to the received indication, the processor 1610 may automatically establish attribute resource values associated with risk attributes based on data in the definition document and store the automatically established attribute resource values associated with risk attributes in a risk relationship data store.

The program 1615 may be stored in a compressed, uncompiled and/or encrypted format. The program 1615 may furthermore include other program elements, such as an operating system, a database management system, and/or device drivers used by the processor 1610 to interface with peripheral devices.

As used herein, information may be “received” by or “transmitted” to, for example: (i) the back-end application computer server 1600 from another device; or (ii) a software application or module within the back-end application computer server 1600 from another software application, module, or any other source.

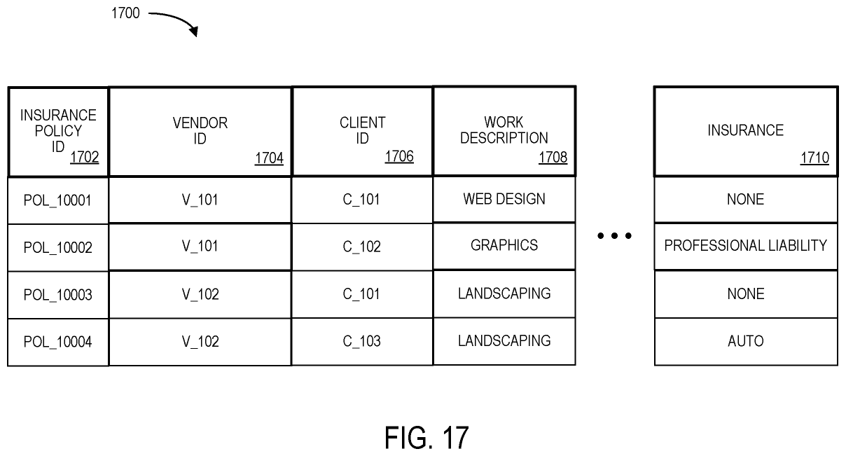

In some embodiments (such as shown in FIG. 16), the storage device 1630 further stores a risk relationship database 1700, a vendor database 1660, a client database 1670, and a statement of work database 1680. An example of a database that might be used in connection with the apparatus 1600 will now be described in detail with respect to FIG. 17. Note that the database described herein is only an example, and additional and/or different information may be stored therein. Moreover, various databases might be split or combined in accordance with any of the embodiments described herein. For example, the risk relationship database 1700 and the vendor database 1660 might be combined and/or linked to each other within the program 1615.

Referring to FIG. 17, a table is shown that represents the risk relation database 1700 that may be stored at the apparatus 1700 according to some embodiments. The table may include, for example, entries associated with insurance policies for task-based freelancing job. The table may also define fields 1702, 1704, 1706, 1708, 1710 for each of the entries. The fields 1702, 1704, 1706, 1708, 1710 may, according to some embodiments, specify: an insurance policy identifier 1702, a vendor identifier 1704, a client identifier 1706, a work description 1708, and insurance data 1710. The risk relation database 1700 may be created and updated, for example, based on information electrically received from various vendors, clients, and computer systems, including those associated with an insurer.

The insurance policy identifier 1702 may be, for example, a unique alphanumeric code identifying (or a link to) a risk relationship between a vendor associated with the vendor identifier 1704 and an enterprise (e.g., an insurance company administering a transaction-based smartphone tool). The client identifier 1706 might identify who requested the freelance work and the work description 1708 might describe the tasks to be performed. The insurance data 1710 might indicate, for example, whether insurance was purchased for the transaction, the type(s) of insurance, etc.

Thus, embodiments may provide an automated and efficient way to provide automated transaction-based risk assignments in a way that provides faster, more accurate results as compared to traditional approaches. Embodiments may be used to leverage a proposal generator to support an underwriting process (without needing to ask additional questions about the potential insured). The application may also help pass on the cost insurance and/or adjust contracts and proposals as appropriate. An enterprise may incrementally expand appetite for various types of risks (e.g., based at least in part on how recent agreements worked out) and gather intelligence about individuals and businesses (e.g., including reputational scores that may be subject to trend analysis by neural networks). This information might impact, according to some embodiments, both insurance underwriting and recommendation decisions.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein (e.g., workers' compensation insurance policies, extreme weather insurance policies, etc.). Similarly, although certain attributes (e.g., values associated with transaction-based insurance policies) were described in connection some embodiments herein, other types of attributes might be used instead.

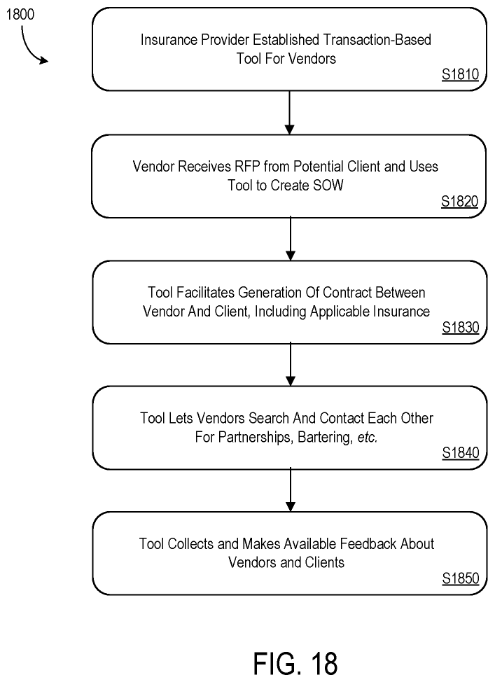

FIG. 18 illustrates an overall business process 1800 in accordance with some embodiments. At S1810, an insurer might establish a transaction-based tool for vendors (e.g., a smartphone application). At S1820, a vendor may receive a RFP from a client and use the tool to create a SOW in response. At S1830, the tool facilitates generation of a contract between the vendor and client along with appropriate insurance coverages. At S1840, the tool lets vendors contact each other (e.g., to form partnerships, barter, make recommendations, etc.). At S1850, the tool collects and provides feedback about the vendors and clients in connection with the transaction-based jobs.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to provide an automated transaction-based risk assignment via a back-end application computer server of an enterprise, comprising:
(a) a risk relationship data store containing electronic records that represent a plurality of risk relationships between the enterprise and a plurality of entities, wherein each electronic record includes a relationship identifier and a set of attribute resource values associated with risk attributes;
(b) the back-end application computer server, coupled to the risk relationship data store, programmed to:
(i) receive an indication of a transaction between a first entity and a second entity,
(ii) interact with the first entity to create a definition document associated with the transaction,
(iii) receive from the first entity an indication that a transaction-based risk relationship should be created with the enterprise in connection with the transaction,
(iv) responsive to the received indication, automatically establish attribute resource values associated with risk attributes based on data in the definition document, and
(v) store the automatically established attribute resource values associated with risk attributes in the risk relationship data store; and
(c) a communication port coupled to the back-end application computer server to facilitate a transmission of data with a remote device to support a graphical interactive user interface display via a distributed communication network, the interactive user interface display providing the automatically established attribute resource values associated with risk attributes.

2. The system of claim 1, wherein the first entity is a vendor, the second entity is a client, and the transaction-based risk assignment is an insurance agreement.

3. The system of claim 1, wherein at least one of the first and second entities comprise at least one of: (i) multiple vendors, and (ii) multiple clients.

4. The system of claim 1, wherein the definition document is a statement of work defining service deliverables to be delivered from a vendor to a client the transaction-based risk assignment is associated with at least one of: (i) professional liability insurance, (ii) general liability insurance, (iii) cyber insurance, (iv) automotive insurance, and (v) any other type of insurance product.

5. The system of claim 1, wherein the indication of the transaction includes at least one of: (i) a client identifier, (ii) a project type, and (iii) a work description.

6. The system of claim 1, wherein the back-end application computer server is further programmed to automatically identify an additional entity similar to the first entity.

7. The system of claim 1, wherein the back-end application computer server is further programmed to arrange for services to be exchanged between the first entity and an additional entity.

8. The system of claim 1, wherein the back-end application computer server is further programmed to facilitate a recommendation of an additional entity by the first entity.

9. The system of claim 1, wherein the back-end application computer server is further programmed to receive feedback information about the transaction.

10. The system of claim 9, wherein the feedback information includes at least one of: (i) a numerical score, (ii) review text, (iii) a picture or video of a competed product, (iv) an overall score, (v) a professionalism score, (vi) a timeliness score, (vii) a quality score, (viii) a value score, (ix) a number of associations, (x) insurance information, (xi) certification information, (xii) profile completeness information, (xiii) activity information, (xiv) references information, and (xv) third-party data.

11. The system of claim 1, wherein the graphical interactive user interface display includes a dashboard interface comparing the first entity to similar entities.

12. A computerized method to provide an automated transaction-based risk assignment via a back-end application computer server of an enterprise, comprising:
receiving, by the back-end application computer server, an indication of a transaction between a first entity and a second entity;
interacting with the first entity to create a definition document associated with the transaction;
receiving from the first entity an indication that a transaction-based risk relationship should be created with the enterprise in connection with the transaction;
responsive to the received indication, automatically establishing attribute resource values associated with risk attributes based on data in the definition document; and
storing the automatically established attribute resource values for the risk attributes in a risk relationship data store, wherein the risk relationship data store contains electronic records that represent a plurality of risk relationships between the enterprise and a plurality of entities, each electronic record including a relationship identifier and a set of attribute resource values associated with risk attributes.

13. The method of claim 12, wherein the first entity is a vendor, the second entity is a client, and the transaction-based risk assignment is an insurance agreement.

14. The method of claim 13, wherein the definition document is a statement of work defining service deliverables to be delivered from the vendor to the client and the insurance agreement is associated with professional liability insurance.

15. The method of claim 11, wherein the back-end application computer server is further programmed to automatically identify an additional entity similar to the first entity.

16. A non-tangible, computer-readable medium storing instructions, that, when executed by a processor, cause the processor to perform a method to provide an automated transaction-based risk assignment via a back-end application computer server of an enterprise, the method comprising:
receiving, by the back-end application computer server, an indication of a transaction between a first entity and a second entity;
interacting with the first entity to create a definition document associated with the transaction;
receiving from the first entity an indication that a transaction-based risk relationship should be created with the enterprise in connection with the transaction;
responsive to the received indication, automatically establishing attribute resource values associated with risk attributes based on data in the definition document; and
storing the automatically established attribute resource values for the risk attributes in a risk relationship data store, wherein the risk relationship data store contains electronic records that represent a plurality of risk relationships between the enterprise and a plurality of entities, each electronic record including a relationship identifier and a set of attribute resource values associated with risk attributes.

17. The medium of claim 16, wherein the back-end application computer server is further programmed to arrange for services to be exchanged between the first entity and an additional entity.

18. The medium of claim 16, wherein the back-end application computer server is further programmed to facilitate a recommendation of an additional entity by the first entity.

19. The medium of claim 16, wherein the back-end application computer server is further programmed to receive feedback information about the transaction.

20. The medium of claim 19, wherein the feedback information includes at least one of: (i) a numerical score, (ii) review text, (iii) a picture or video of a competed product, (iv) an overall score, (v) a professionalism score, (vi) a timeliness score, (vii) a quality score, (viii) a value score, (ix) a number of associations, (x) insurance information, (xi) certification information, (xii) profile completeness information, (xiii) activity information, (xiv) references information, and (xv) third-party data.
